(19) United States
(12) Patent Application Publication
(10) Pub. No.: US 2008/0294332 A1
(43) Pub. Date: Nov. 27, 2008

(54) Method for Image Based Navigation Route Corridor For 3D View on Mobile Platforms for Mobile Users

(75) Inventors: Issac LEVANON, Raanana (IL); Yonatan LAVI, Raanana (IL)

Correspondence Address: Lilling & Lilling PLLC, PO Box 435, Jerusalem, 91003, IL

(73) Assignee: 3-D-V-U Israel (2000) Ltd., Raanana (IL)

(21) Appl. No.: 12/015,068

(22) Filed: Jan. 16, 2008

Related U.S. Application Data
(60) Provisional application No. 60/880,674, filed on Jan. 17, 2007.

(51) Int. Cl. G01C 21/36

(52) U.S. Cl. 701/200

(57) ABSTRACT

The invention proposes a method for displaying an image based navigation route corridor for 3D view on mobile platforms for mobile users. The invention comprises the combination of some technical solutions. 1. Display of a relevant area around a selected or calculated route (route corridor). 2. Selection of the relevant area that is a small dataset. 3. Creation of the customized route corridor dataset. 4. Provide 3D viewers ability to allow the display of the created route corridor in 2D, isometric view, or 3D perspective and then allow 3D maneuverability over the created route corridor. Combination of these technical solutions comprises a method of facilitating the display of the route corridor on mobile computing platform in 3D perspective.

### FIELD OF THE INVENTION

The present invention is directed to facilitating a navigational route corridor over imagery in 3D perspective for users of mobile computing platforms via a dynamic retrieval of Region Of Interest (ROI) as a subset from a navigation and/or Geographic Information System (GIS) database(s).

### BACKGROUND

Modern commuters use different types of mobile/portable computing platforms to obtain various navigation services. Mobile/portable computing platforms that provide navigation features and services include both dedicated computing devices and general purpose computing devices. Dedicated computing devices include in-vehicle navigation systems, personal (i.e., portable or hand-held) navigation devises (PNDs) and personal travel assistance (PTA) systems. General-purpose computing devices include portable personal computers such as notebook computers, and personal digital assistants (PDAs). General purpose computing devices can provide navigation features and services by operating application software and by using geographic data. Mobile or portable computing platforms that provide navigation features and services include standalone systems that have geographic data and navigation application software installed locally, client devices that access geographic data or navigation application software located at a remote location, and hybrid devices that have some geographic data or navigation application software installed locally but obtain or use geographic data or navigation application software located at a remote location.

Some of the various geographically-related features and services provided by the different types of mobile or portable computing platforms include route calculation and guidance. For example, some mobile/portable computing platforms provide users with optimum routes for road travel between the present location and a target destination within the geographic region.

Using the user's conscious input, and optionally automatic input regarding the user's physical location, such as via a GPS system, a navigation application program running on or accessible by a mobile or portable computing platform system examines various paths between the starting point and target destination to determine the optimal route of travel there between. The user of the mobile or portable computing platform is then provided with information about the optimum route in the form of instructions that identify the maneuvers required to be taken by the end user to travel from the starting location to the destination location.

Another geographically-related feature provided by some mobile/portable computing platforms is a business or person locating service, commonly referred to as electronic yellow or white pages. Such a service can identify addresses of individuals or businesses. These services can also identify for a user which businesses of a certain type (e.g., Chinese restaurants) are located within a given range (e.g., 3 miles) of a given location.

Another geographically-related feature provided by some mobile or portable computing platforms provides information to end users based upon their location. Some types of information, such as advertising, provide directed information based upon the user's location, delivering advertising to end users who are traveling in a geographic region.

A further geographically-related feature provided by some mobile or portable computing platforms provides details concerning 3D building for urban navigation. Such urban navigation attempts to provide a virtual representation of the real world by building shape, height, facade textures and images into 3D models. With appropriate 3D viewers, the urban scene is rendered on the computing device. New advances in technology in both hardware and software will transform the bird-eye-view to street-view where the virtual 3D buildings becoming part of advance urban navigation system to be found in most mobile and portable devices in the near future.

Although present mobile/portable computing platforms that provide geographically-related features and services are able to provide many useful advantages, there is room for further improvement.

The purpose of this invention is to provide a solution for the off-line visualization of memory-consuming datasets such as aerial photography, terrain elevation and 3D buildings, within the storage and connectivity limitations of today's mobile/portable computing platforms as navigation products, such as Personal Navigation Devices (PND's). Typically, such a system cannot maintain a connection to a remote database server, and thus has to store all visualized content in its own storage devices, which don't have nearly enough space to store the entire database.

### SUMMARY OF THE INVENTION

It is an objective of the invention to provide intuitive 3D virtual reality navigation for navigating users on a mobile computing platform.

It is another objective to provide a means to overcome the limitation associated with mobile devices that are limited in processing power and storage area to present, in 3D perspective, the area surrounding a route using imagery and other navigational and GIS (Geographic Information System) based elements and databases such as but not limited to terrain elevation, point of interest (POIs), and 3D buildings which may cover very large area such as entire continents and by an image based dataset, that required very large dataset compare to the traditional vector map and route presented on a vector generated map.

To address these and other objectives, in a first aspect, the present invention comprises a method of facilitating the display of a Region-of-Interest (ROI) and more specifically a relevant area around a selected or calculated route (route corridor), presented on the aerial or satellite image with or without additional navigational elements such as terrain elevation, POIs, and 3D buildings.

To allow the selection of relevant area that is a small dataset that may or may not be customized, as a subset from large size databases. This invention supports any formally defined ROI within the limitations of the technique used to create an ordering on the database nodes. The invention supports ROIs described as arbitrarily complex planar graphs, and general polygonal meshes. This naturally covers route(s) and/or closed area(s).

To allow the customized creation of the route corridor dataset, based on limitations dictated or controlled by others or set/preset by the user, covering among others but not limited to, communication bandwidth to the device, and storage space, whether on fixed or removable media, processing power and memory availability or allocated in the device that display the route corridor.

In a second aspect a 3D viewer is provided to allow the display of the created route corridor in 2D, Isometric view or 3D perspective and then to allow 3D maneuverability over the created route corridor, including, but not limited to, the movement over the route corridor that may or may not be in any adjustable, preset or controlled by the user; direction from origin to target or vise versa, angle of view, height, zoom level and speed.

To address these and other objectives, in a second aspect, the present invention comprises a method of facilitating the display of such ROI as route corridor on mobile computing platform in 3D perspective.

### BRIEF DESCRIPTION OF THE FIGURES

For a better understanding of the invention and to show how it may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention; the description taken with the drawings making apparent to those skilled in the art how the several forms of the invention may be embodied in practice. In the accompanying drawings:

FIG. 1 is a schematic 3D perspective of a virtual area illustrating an embodiment for representing 3D route corridor and associated navigation and GIS elements;

FIG. 2 is a flowchart of the method used to construct FIG. 1;

FIG. 3 illustrates database structure, file system, and data flow of FIG. 2; and

FIG. 4 (a-e) illustrates a dynamic creation of ROI based on storage size availability used in 2D and 3D virtual scenery of FIG. 1;

### DESCRIPTION OF THE PREFERRED EMBODIMENTS

A method and apparatus for the construction of an ordering relation between the nodes of a navigation, mapping or GIS database, based on a formal description of a Region-of-Interest (ROI), and its use in a streaming read (download) process to build a subset of the original database is disclosed.

This process may be terminated at any time, depending on programmable conditions, and all nodes that were successfully retrieved are then used to produce an off-line version of the database that provides the ability to view the relatively more important information in an off-line application that does not have access to the original database. Users of mobile computing platforms are provided with a viewer that renders this off-line database, displaying the ROI as a route “corridor” in 2D, Isometric view or 3D perspective.

This invention in its general form is known as “caching”, and is in widespread use. The invention is a novel application of this technique, in a specific way that outperforms a general-purpose cache mechanism applied on an on-line viewer to produce a database for the off-line application.

More specifically, we focus on a scenario where the user would like to plan a route between several known locations A₁, . . . , Aₙ. The ROI is determined as a subset of the road network (a sub-graph, as this network can be seen as a planar graph), containing one or more of the shortest (or otherwise best in respect to some quantifiable metric) routes starting in Aᵢ and reaching Aᵢ₊₁, for any value of i in {1, . . . , n−1}. However, this is just an example; the proposed method isn't directly dependent on the exact details of the how the ROI geometry is constructed.

The ordering relation between the nodes is constructed by assigning a real number (called priority) for any node N in the database.

The GIS database employs a spatial subdivision scheme, so that each node in the database corresponds to a certain (possibly unbound) region. The priority assigned to any given node is computed as a function G of this region. A scalar field F is constructed given the ROI specifications, and then G(N) is defined as the integral of F over N's region. One method of construction for F(x) is as some decreasing function of d(x), being the minimal distance between the geometry of the ROI and x. Taking a hyperbolic function such as F(x)=1/(c+d(x)^{p}) for some constants c>0, p>0 in particular achieves a good balance in terms of the tradeoff between detail and coverage for regular (constant-density) datasets such as aerial photography.

The streaming read process begins traversing the database, always selecting the node with the highest evaluated priority and then retrieves that node. On tree-based data structures, such as Binary Space Partitioning (BSP) trees, Kd-trees or quad-trees, this can be implemented using an algorithm similar to Breadth-First Search (BFS) only using a priority queue instead of a regular First In, First Out (FIFO) queue. The scan is stopped when the conditions for termination apply (such as when a size limit is exceeded, or by an instruction from the user), or if the queue of available nodes is exhausted.

This invention can also be applied simultaneously on multiple source databases that would share the same off-line storage, simply by extending the order relation to apply between any two nodes from any two source databases. Also, the relative priority of nodes can be adjusted according to their relative memory cost-efficiency. Vector graphics data, for example, is vastly more memory-efficient than aerial photography, informally meaning that it provides more useful information for navigation purposes “per byte”, and thus should receive better priority. These techniques allow the system to manage the available storage for the off-line application more intelligently.

This invention has the following advantages in relation to general-purpose caching:
1. To prepare a cache for off-line use, an on-line viewer would normally have no way to access and visualize all database nodes near or inside the ROI at the same time, so instead, the viewer would have to examine different combinations of positions and resolution levels, making it much more difficult to prioritize between the nodes of each database and even more so between different databases. It would take the evaluation of many different combinations because “spacing out” between the positions too much result in aliasing problems, making this approach almost impractical for complex ROIs such as those produced by long-distance route planning.
2. A general-purpose read cache is typically used as a transparent layer of abstraction, in that the viewer reads “through” the cache without being aware of its existence. However, in the case of an off-line viewer, there is an issue that some seemingly accessible nodes in the databases may not exist in the cache, and thus cannot be retrieved—this type of failure may occur for any query to the database done by the application. In contrast, the off-line database created by the method herein is easier to use since all of its nodes are available off-line.
3. The hierarchy traversal used by this method can be seen as a “generator” for database node references, so by simply buffering these references it is easy to achieve high performance in the streaming read process by keeping multiple simultaneous requests to the server. This takes care of the otherwise unreasonable time cost of waiting on the I/O, which would be the connection's latency times the total amount of nodes retrieved. However, implementing this optimization in an on-line viewer is more difficult, because it typically maintains the requests for nodes corresponding to one specific resolution/position combination only; also, it has no way to estimate in real time what are the next k highest-priority nodes (in regards to the entire ROI), which could make it download lesser-priority nodes that might not make it into the final cache at all, resulting in a waste of resources.

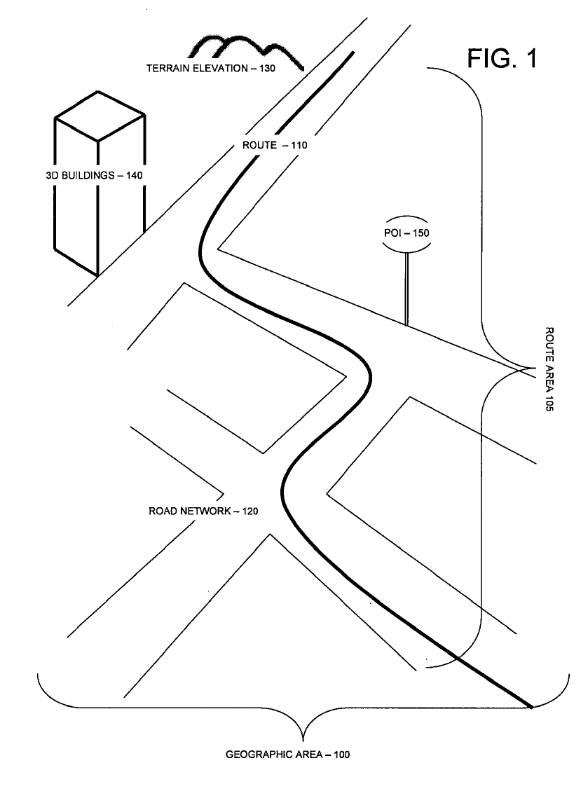

With reference now to FIG. 1 a schematic 3D perspective of the geographic area 100. In a present embodiment, the display of the route area 105 defines a plurality of road networks 120, terrain elevations 130, 3D buildings 140 and POIs 150 and a route 110 within the geographic area 100.

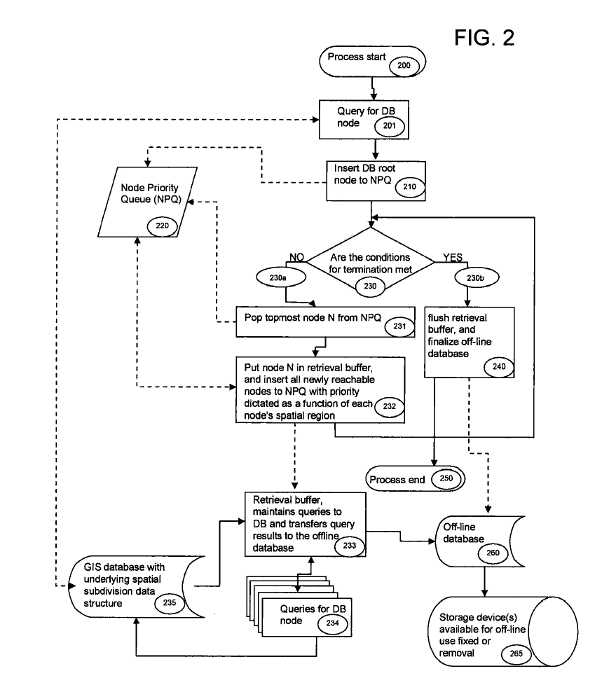

FIG. 2 is a flow chart of the method used to produce the database from which to render images as depicted in FIG. 1. At process start 200 the system sends a query 201 to the GIS database 235 and retrieves necessary information in order to be able to query the database for the root node of the spatial subdivision hierarchy, and then retrieves it and inserts it to the Node Priority Queue (NPQ) 220. The process then enters a loop 230, under termination conditions such as time and/or space limits. If the termination conditions are not met 230a, the program removes a single node from the NPQ 220, and places it in the retrieval buffer 233. The program then evaluates the priority of all children of that node in the hierarchy. For each such node 232, an evaluation function is applied on the spatial region defined by that node in the spatial subdivision data structure. The result of this function is then used as priority and the node is inserted with that priority to the NPQ 220. Then the process loops back to 230.

The retrieval buffer 233 maintains a list of queries 234 to the GIS database 235 consisting of nodes removed from the NPQ so far that have not yet been received. It may block the operation of step 232 to prevent the system from growing the buffer indefinitely. When a buffered query completes successfully, it stores the data and node information in preparation for use in the final off-line database 260.

When the termination condition of the loop is met 230b, the process 240 flushes the retrieval buffer 233, and finalizes the off-line database 260 from the data provided so far from the queries made by the retrieval buffer 233, so that it can then be used by the off-line application in place of the original database. It then transfers this database to the storage device(s) 265 used by the off-line application. After this, the process terminates 250.

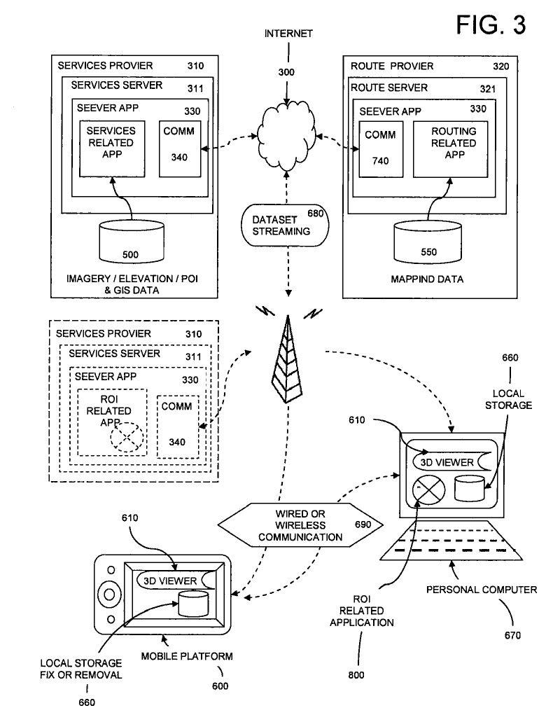

FIG. 3 illustrates a ROI system used in 3D virtual scenery of FIG. 1. The system comprised of a services provider 310 and route provider 320 and optional ROI provider 810. Whereby the services provider utilize a services server 311 and the route provider utilize a route server 321. Said services server 311 and route server 321 and ROI server 811, may utilize server application 330 to operate said servers. A related services application 312 may be controlled by said server application 330 for the services provider 310 that is connected to imagery, data storage 500 comprised of polarity of imagery, terrain elevation, POIs and GIS datasets, and route related application 322 may be controlled by said server application 330 for the route provider 320 that is connected to mapping data 550, and ROI related application 800 may be controlled by said server application 330 for the ROI provider 810 that is connected to services provider 310 and route provider 320 via the Internet 300 or directly. The server application 330 also may control a communication application 340 that connected each said server and services to the Internet 300.

Said Internet 300 provides for a dataset streaming 680 via wired 681 or wireless 682 communications.

ROI related application 800 may be installed on the user personal computer 670, whereby relevant data streamed over the Internet 300 from the services provider 310 and route provider 320 is manipulated by the ROI related application 800 to create the target ROI for a said route. The personal computer 670 may contain a 3D viewer 610 to preview the route and the ROI. Said ROI may be stored on the local storage 660 in the personal computer 670.

The selected ROI may be streamed via wired or wireless communication 690 to the mobile platform 600 from the ROI provider 810 and/or from the user's personal computer 670 local storage 660. The said transferred ROI will be stored in the mobile platform 600 storage media 680 that can be fixed or removable media.

The mobile platform may contain a 3D viewer in order to view the said ROI. The mobile platform may contain internally or connected via wire or wireless to locator device such as GPS in order to track the user mobile platform location and place the location over the displayed ROI.

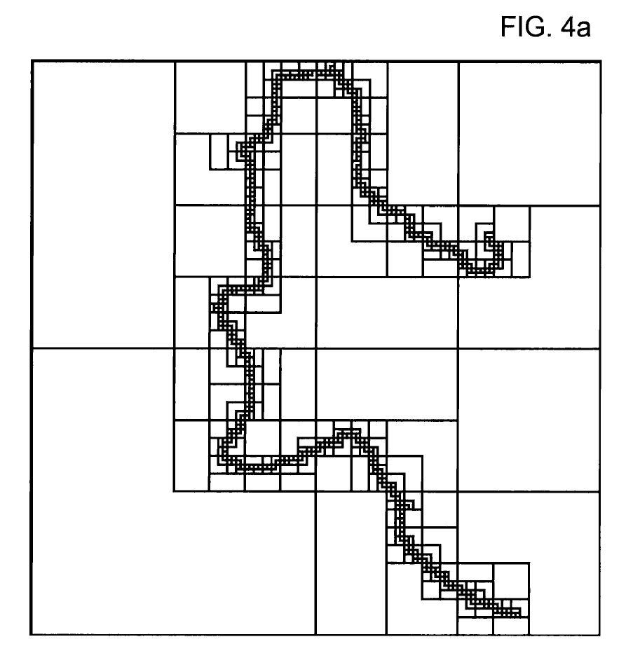

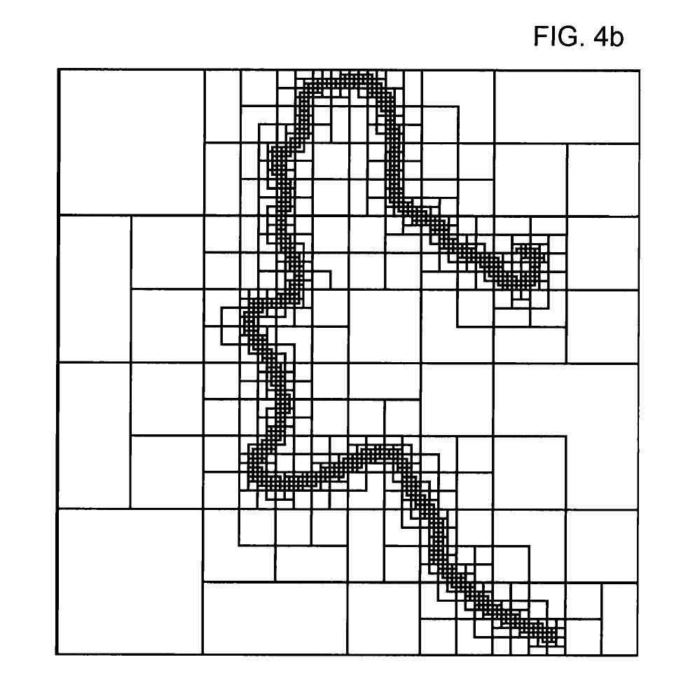

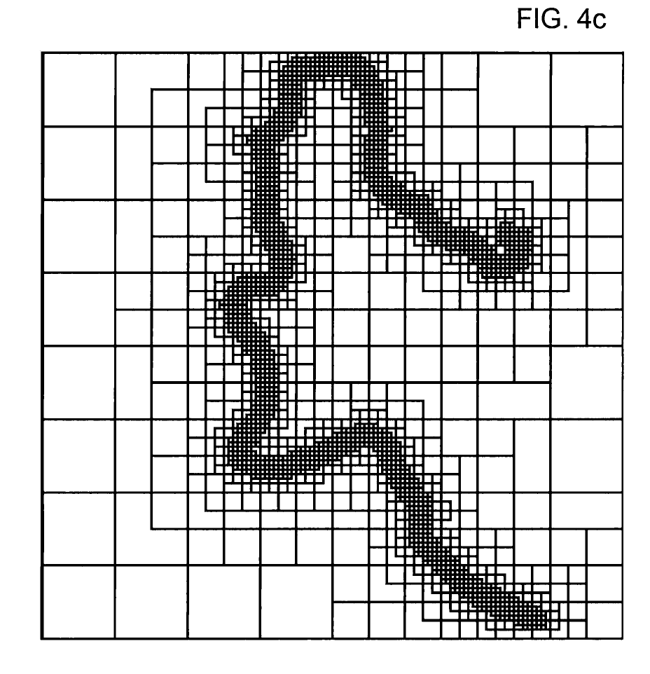

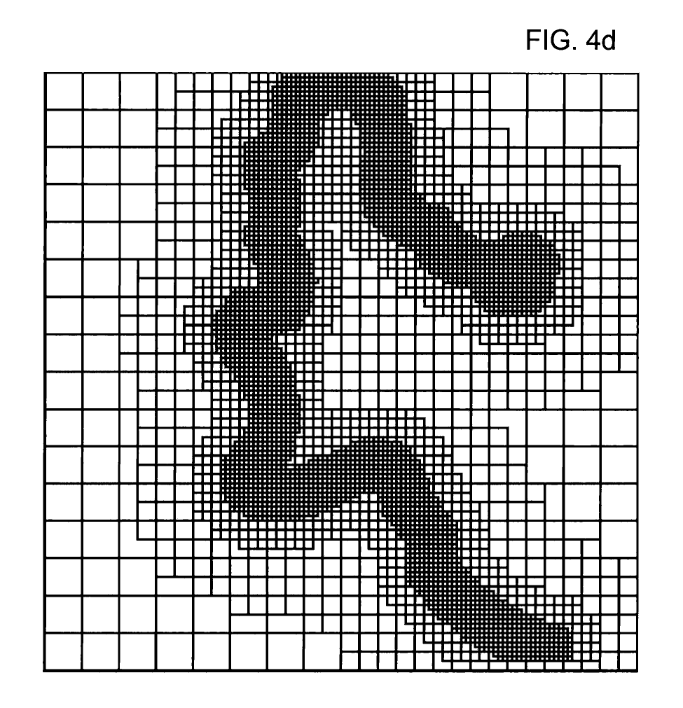

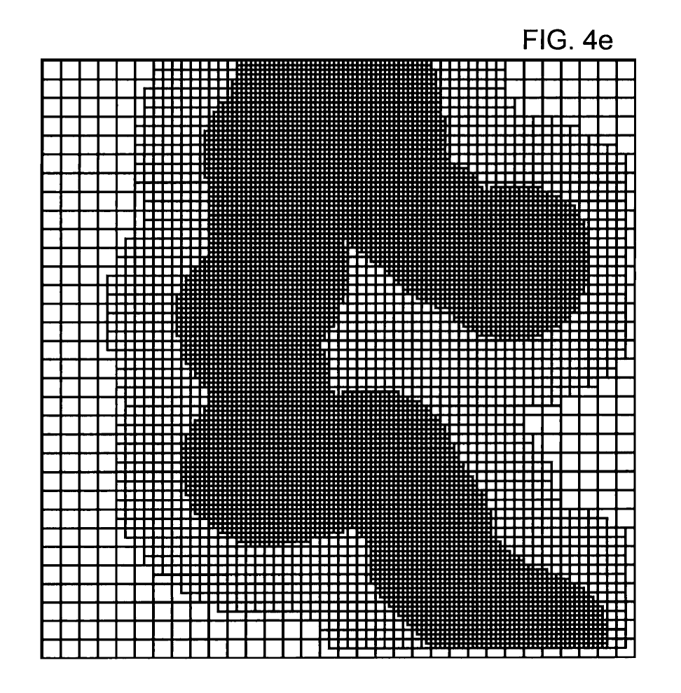

FIG. 4 (a-e) shows the set of nodes selected from a quad-tree based database, using a simple ROI created by a route connecting between two locations, with varying limits on the size of the output database produced. The more memory is allotted, the more nodes surrounding the ROI can make it into the output database. Each node is shown graphically as a square depicting its region as defined by the quad-tree's spatial subdivision.

Thus the scope of the present invention is defined both combinations and sub combinations of the various features described hereinabove as well as variations and modifications thereof, which would occur to persons skilled in the art upon reading the foregoing description.

In the claims, the word “comprise”, and variations thereof such as “comprises”, “comprising” and the like indicate that the components listed are included, but not generally to the exclusion of other components.

We claim:

1. A method of generating and facilitating the display of a Region-of-Interest (ROI) to users of mobile computing platforms:
Said ROI comprising of a relevant area around a selected or calculated navigational route namely route corridor
Said ROI generated from datasets comprising of some or the combination of imagery, terrain elevation, Point-Of-Interests, and 3D objects such as but not limited to 3D building with or without their images facades as graphic or raster
Said datasets are located on local or remote server
Said route is selected or calculated from a local or remote sever
Said ROI generator function on local or remote server such server may be a hosted server or personal computer (PC)
Said ROI generator determine the region of interest based on the information provided from the said selected or calculated route
Said POI is small subset of the datasets indicated above
Said ROI described as arbitrarily complex planar graphs, and general polygonal meshes. This naturally covers route(s) and/or closed area(s)
Said ROI datasets is placed on the device storage, fixed or removable media
Said ROI generator allow the customized creation of the route corridor dataset, based on limitations dictated or controlled by others or set/preset by the user, covering among others but not limited to, communication bandwidth to the device, and storage space, whether on fixed or removable media, processing power and memory availability or allocated in the device that display the route corridor.
Said ROI rendered on the device graphics display
